(19) United States
(12) Patent Application Publication
(10) Pub. No.: US 2011/0317307 A1
(43) Pub. Date: Dec. 29, 2011

(54) Motor and recording disc driving device

(75) Inventor: Chang Jo Yu, Suwon (KR)

(73) Assignee: SAMSUNG ELECTRO-MECHANICS CO., LTD., Suwon (KR)

(21) Appl. No.: 13/064,635

(22) Filed: Apr. 5, 2011

(30) Foreign Application Priority Data
Jun. 28, 2010 (KR) 10-2010-0061435

(51) Int. Cl. H02K 7/08; G11B 21/02; H02K 21/22

(52) U.S. Cl. 360/75; 310/156.04; 310/90; G9B/21.003

(57) ABSTRACT

There are provided a motor and a recording disc driving device, which may minimize a frictional force between a shaft and a bearing assembly to enable a rotor to be readily rotated at the time of initial movement of the rotor. The motor may include: a bearing assembly including a shaft rotatably fastened to the bearing assembly; a base fastened to a lower end portion of the bearing assembly; a stator fastened to the base and including a winding coil; and a rotor case fastened to an upper end portion of the shaft, and including a magnet fastened to the rotor case to be positioned to face the winding coil, wherein the magnet is fastened to the rotor case in such a manner as to be protruded towards a lower portion of the rotor case so that a magnetic force due to an eddy current generated in the base is increased.

### CROSS-REFERENCE TO RELATED APPLICATIONS

This application claims the priority of Korean Patent Application No. 10-2010-0061435 filed on Jun. 28, 2010, in the Korean Intellectual Property Office, the disclosure of which is incorporated herein by reference.

### BACKGROUND OF THE INVENTION

1. Field of the Invention

The present invention relates to a motor and a recording disc driving device, and more particularly, to a motor and a recording disc driving device, which may lift a rotor using an eddy current generated in a base by a magnet when the rotor is rotated.

2. Description of the Related Art

A small-sized spindle motor used in a recording disc driving device may be a device in which a fluid dynamic pressure-bearing assembly is used, in which oil is disposed between a shaft of the fluid dynamic pressure-bearing assembly and a sleeve thereof, and the shaft is supported by fluid pressure generated by the oil.

In addition, the spindle motor may be rotated together with the shaft, such that a rotor in which a magnet is mounted on the shaft is fastened to the spindle motor. The spindle motor may be configured such that a stator is fastened to an outer surface of the bearing assembly, and the rotor is rotated by electromagnetic force generated by power applied to a coil of the stator.

When the rotor is rotated, the spindle motor may generally enable the rotor to be upwardly lifted by a rotational force. Accordingly, in the related art, to prevent the rotor from being excessively lifted, a pulling plate formed of soft magnetic materials such as iron, silicon, steel, and the like may be installed in a lower portion of the magnet of the rotor. The pulling plate may be fastened to a base adjacent to the magnet, and may function to prevent the rotor from being lifted using an attraction force mutually exerted between the magnet and the pulling plate.

However, since a conventional spindle motor uses the pulling plate, an attraction force between the rotor and the base may be basically exerted. In this regard, a strong fractional force between the shaft and the bearing assembly supporting a lower end of the shaft may be created when movement of the rotor is initiated.

Since frictional force acts as a factor in impeding the initial movement of the rotor, there is an urgent need for minimizing the frictional force acting thereon.

### SUMMARY OF THE INVENTION

An aspect of the present invention provides a motor and a recording disc driving device, which may minimize frictional force between a shaft and a bearing assembly so that a rotor may be readily rotated at the time of initial movement of the rotor.

According to an aspect of the present invention, there is provided a motor, including: a bearing assembly including a shaft rotatably fastened to the bearing assembly; a base fastened to a lower end portion of the bearing assembly; a stator fastened to the base and including a winding coil; and a rotor case fastened to an upper end portion of the shaft, and including a magnet fastened to the rotor case to be positioned to face the winding coil, wherein the magnet is fastened to the rotor case in such a manner as to be protruded towards a lower portion of the rotor case so that a magnetic force due to an eddy current generated in the base is increased.

The base may be formed of a non-magnetic substance.

The base may be formed of an aluminum alloy material.

The motor may further include an eddy current generating part fastened to the base to face a lower surface of the magnet, and formed of an aluminum alloy material.

The bearing assembly may include a thrust dynamic pressure generating part generating a fluid dynamic pressure to a lower side of an axial direction to prevent the rotor case from being lifted.

The thrust dynamic pressure generating part may include a first thrust dynamic pressure generating part generating the fluid dynamic pressure to the lower side of the axial direction, and a second thrust dynamaic pressure generating part generating the fluid dynamic pressure to an upper side of the axial direction, and the fluid dynamic pressure generated in the first thrust dynamic presusre generating part may be greater than the fluid dynamic pressure generated in the second thrust dynamic pressre generating part.

The bearing assembly may include: a sleeve formed to have a cylinderical shape, and supporting the shaft to be rotatable; a thrust plate formed to have a ring shape, fixedly fastened to a lower end portion of the shaft, and positioned in a lower space of the sleeve; and a sleeve holder formed to have a cylinderical shape, and receiving the shaft, the sleeve, and the thrust plate therein.

The thrust dynamic pressure generating part may be formed on an upper surface of the thrust plate facing a lower surface of the sleeve, and on a lower surface of the thrust plate facing a bottom surface of the sleeve holder, respectively.

A fluid dynamic pressure generated in the thrust dynamic pressure generating part formed on the upper surface of the thrust plate may be greater than a fluid dynamic presusre generated in the thrust dynamic pressure generating part formed on the lower surface of the thrust plate.

The thrust dynamic presusre generating part may be formed on the lower surface of the sleeve facing the upper surface of the thrust plate, and on the bottom surface of the sleeve holder facing the lower surface of the thrust plate, respectively.

A fluid dynamic pressure generated in the thrust dynamic pressure generating part formed on the lower surface of the sleeve may be greater than a fluid dynamic pressure generated in the thrust dynamic pressure generating part formed on the bottom surface of the sleeve holder.

According to another aspect of the present invention, there is provided a motor, including: a bearing assembly including a shaft rotatably fastened to the bearing assembly; a base fastened to a lower end portion of the bearing assembly; a stator fastened to the base and including a winding coil; and a rotor case fastened to an upper end portion of the shaft, and including a magnet fastened to the rotor case to be positioned to face the winding coil, wherein the bearing assembly includes a thrust dynamic pressure generating part generating a fluid dynamic pressure to a lower side of an axial direction to prevent the rotor case from being lifted.

According to another aspect of the present invention, there is provided a recording disc driving device, including; the motor; a head tranfer part transfering, to a recording disc, a head for detecting information of the recording disc loaded in the motor; and a housing receiving the motor and the head transfer part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an exemplary embodiment of the present invention;

FIG. 2A is a view showing a first thrust dynamic pressure generating part of FIG. 1;

FIG. 2B is a view showing a second thrust dynamic pressure generating part of FIG. 1;

FIG. 3 is a schematic cross-sectional view showing a motor according to another exemplary embodiment of the present invention;

FIG. 4 is a schematic cross-sectional view showing a motor according to still another exemplary embodiment of the present invention; and

FIG. 5 is a schematic cross-sectional view showing a recording disc driving device to which a motor according to an exemplary embodiment of the present invention is mounted.

### DETAILED DESCRIPTION OF THE PREFERRED EMBODIMENT

Before describing the detailed description of the present invention, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention. Therefore, the exemplary embodiments detailed in the detailed description and the configurations in the drawings are merely exemplary embodiments of the present invention and do not represent all of the technical ideas of the present invention. Therefore, it should be understood that there may be various equivalents and modifications capable of replacing them at the time of filing.

Hereinafter, exemplary embodiments of the present invention will be described in detail with reference to the accompanying drawings. Like reference numerals in the drawings denote like elements throughout the specification. In addition, in describing the present invention, a detailed description of related known functions or configurations will be omitted so as not to obscure the subject of the present invention. Based on the same reason, in the drawings, some of components are exaggerated or omitted or are schematically illustrated, and a size of each component does not completely reflect the actual size thereof.

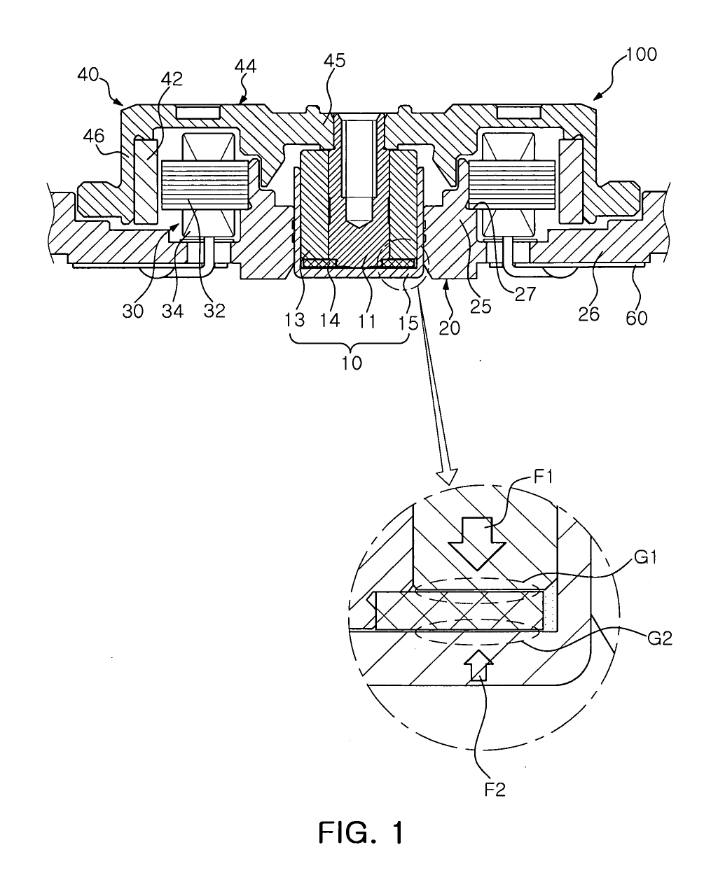

Meanwhile, terms relating to the directions will be defined as follows. As shown in FIG. 1, an axial direction may denote a vertical direction with respect to a shaft 11, and outer and inner diameter directions may denote an outside edge direction of a rotor 40 with respect to the shaft 11 or a central direction of the shaft 11 with respect to an outside edge of the rotor 40.

Exemplary embodiments of the present invention will now be described in detail with reference to the accompanying drawings.

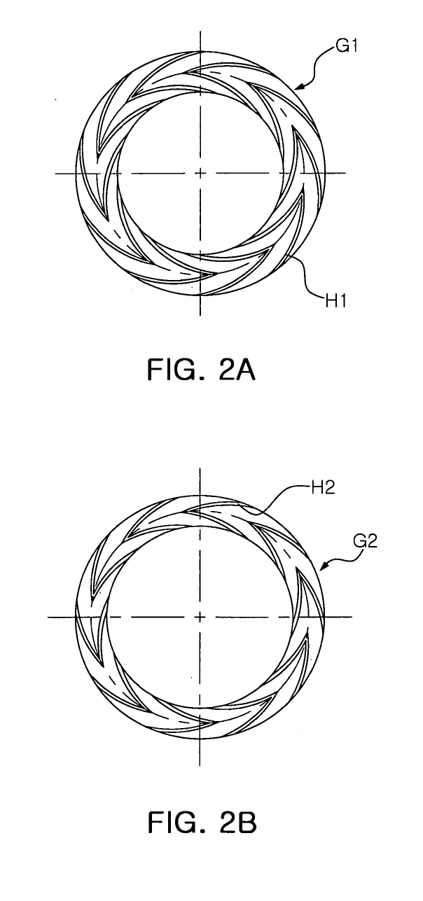

FIG. 1 is a schematic cross-sectional view showing a motor according to an exemplary embodiment of the present invention, FIG. 2A is a view showing a first thrust dynamic pressure generating part of FIG. 1, and FIG. 2B is a view showing a second thrust dynamic pressure generating part of FIG. 1.

First, referring to FIG. 1, a motor 100 according to the present exemplary embodiment may be a spindle motor 100 applied to a hard disk drive (HDD), and include a stator 30, the rotor 40, a bearing assembly 10, and a base 20 where a circuit board 60 is provided.

The stator 30 may be a fixed structure, and include a core 32 and a winding coil 34 wound around the core 32.

The core 32 according to the present exemplary embodiment may be formed of a plurality of iron plates laminated to one another, and may be radially extended in an outer diameter direction of the shaft 11 with respect to the shaft 11. The core 32 may be fixedly fastened to an outer circumferential surface of the base 20, which will be described later.

The winding coil 34 may be a coil wound around the core 32, and generate an electromagnetic force when power is applied. The winding coil 34 according to the present exemplary embodiment may be electrically connected to the circuit board 60, which will be described later, so that the power may be supplied to the winding coil 34 from the circuit board 60.

The rotor 40 may include a magnet 42 and a rotor case 44.

The magnet 42 may be an annular ring-shaped permanent magnet that generates electromagnetic force of a predetermined intensity such that an N-pole and an S-pole are alternately magnetized in a circumferential direction.

The rotor case 44 may be formed to have a cup-shape, and include a rotor hub 45 and a magnet coupling part 46.

The rotor hub 45 may be fastened to an upper end portion of the shaft 11.

The magnet coupling part 46 to which the magnet 42 is fastened may be formed such that the magnet 42 is disposed to be fastened to the magnet coupling part 46 in such a manner as to face the core 32 of the stator 30 along an inner circumferential surface of the rotor case 44. Accordingly, when power is applied to the winding coil 34 wound around the core 32, the rotor 40 may be rotated by electromagnetic interaction between the magnet 42 and the winding coil 34.

The bearing assembly 10 may be an assembly that may support the shaft 11 to enable the shaft 11 to be rotated, and include the shaft 11, a thrust plate 14, a sleeve 13, and a sleeve holder 15.

The shaft 11 may form a rotating shaft of the rotor 40, which will be described later, and may be supported by a sleeve 13, which will be described later, in such a manner that an upper end of the shaft 11 may be protruded to an upper side of an axial direction.

The thrust plate 14 may be formed to have a ring shape, and may be fixedly fastened to a lower end portion of the shaft 11 in such a manner as to be rotated together with the shaft 11. In this instance, the thrust plate 14 may be fastened to be protruded towards a lower portion of the sleeve 13, which will be described later. Accordingly, the thrust plate 14 may be positioned in a lower space of the sleeve 13, and act as a stopper that prevents the rotor 40 from being upwardly lifted, or from being separated from the bearing assembly 10 when the rotor 40 is rotated.

The sleeve 13 may be a rotation support member supporting the shaft 11. The sleeve 13 may be formed to have a cylindrical shape, and the shaft 11 may be inserted into a hole formed in an inside of the sleeve 13.

The motor 100 according to the present exemplary embodiment may use a fluid dynamic pressure bearing. Accordingly, in the motor 100 according to the present exemplary embodiment, fluid may be disposed between the sleeve 13 and the shaft 11 so that the shaft 11 may be readily rotated in the inside of the sleeve 13. The fluid may act as a lubricant minimizing friction between the shaft 11 and the sleeve 13 when the shaft 11 is rotated.

In addition, the motor 100 according to the present exemplary embodiment may include a plurality of radial dynamic pressure holes (not shown) generating a fluid dynamic pressure formed on a side of an outer diameter portion of the shaft 11 or an inner diameter portion of the sleeve 13. The shaft 11 may be readily rotated within the sleeve 13 by the fluid dynamic pressure generated by the plurality of radial dynamic pressure holes.

The sleeve holder 15 may be formed to have a cylindrical shape, and receive the sleeve 13, the shaft 11, and the thrust plate 14 therein. An outer circumferential surface of the sleeve holder 15 may be press-fitted to and fixed to an inside of the base 20, which will be described later.

The motor 100 according to the present exemplary embodiment may include thrust dynamic pressure generating parts G1 and G2. The thrust dynamic pressure generating parts G1 and G2 according to the present exemplary embodiment may function to lift the rotor 40 by a predetermined interval when the rotor 40 is rotated, at the same time as rotation, and function to prevent the rotor 40 from being excessively lifted. For this, the thrust dynamic pressure generating parts G1 and G2 according to the present exemplary embodiment may include a first thrust dynamic pressure generating part G1 formed on a lower surface of the sleeve 13 facing an upper surface of the thrust plate 14, and a second thrust dynamic pressure generating part G2 formed on a bottom surface of the sleeve holder 15 facing a lower surface of the thrust plate 14.

In particular, the thrust dynamic pressure generating parts G1 and G2 according to the present exemplary embodiment may generate a fluid dynamic pressure to a lower side in an axial direction to prevent the rotor case 44 from being lifted. Accordingly, in the thrust dynamic pressure generating parts G1 and G2 according to the present exemplary embodiment, a fluid dynamic pressure generated in the first thrust dynamic pressure generating part G1 may be greater than a fluid dynamic pressure generated in the second thrust dynamic pressure generating part G2.

This may be implemented by a variety of schemes such as forming an outer diameter of the second thrust dynamic pressure generating part G2 as being smaller than an outer diameter of the first thrust dynamic pressure generating part G1, or such as forming a depth, a width, or a number of dynamic pressure grooves H1 formed in the first thrust dynamic pressure generating part G1 as being deeper, wider, or larger than a depth, a width, or a number of dynamic pressure grooves H2 formed in the second thrust dynamic pressure generating part G2, and the like, as shown in FIGS. 2A and 2B.

Meanwhile, the thrust dynamic pressure generating parts G1 and G2 according to the present exemplary embodiment may not be limited to the above described manners, such as being formed in the lower surface of the sleeve 13 and the bottom surface of the sleeve holder 15. That is, it may be possible that the first thrust dynamic pressure generating part G1 be formed on the upper surface of the thrust plate 14 facing the lower surface of the sleeve 13, and the second thrust dynamic pressure generating part G2 be formed on the lower surface of the thrust plate 14 facing the bottom surface of the sleeve holder 15. Otherwise, a combination of these may be also possible. In this case, as described above, the fluid dynamic pressure generated in the first thrust dynamic pressure generating part G1 may be greater than the fluid dynamic pressure generated in the second thrust dynamic pressure generating part G2.

In addition, the thrust dynamic pressure generating parts G1 and G2 according to the present exemplary embodiment may be formed to have a herringbone shape, and a pattern of the dynamic pressure grooves H1 and H2 may be formed on the thrust dynamic pressure generating parts G1 and G2, however, the present invention is not be limited thereto. Thus, various applications such as forming the pattern of the dynamic pressure grooves H1 and H2 as being formed to have a spiral shape and the like may be possible.

A circuit pattern (not shown) applying power to the motor 100 may be formed in an inside of the circuit board 60, and electrically connected to the winding coil 34 to apply the power to the winding coil 34. Also, a ground pattern among the circuit patterns of the circuit board 60 may be formed to be in electrical conduction with the base 20. As the circuit board 60, various boards such as a general printed circuit board (PCB), a flexible PCB, and the like may be selectively used, as necessary.

The base 20 may be a support member supporting overall components of the motor 100, and include a sleeve support part 25 supporting the shaft 11 to be rotated using the sleeve 13 as a mediator and a plate part 26 where the circuit board 60 is attached to a lower surface of the base 20. The sleeve support part 25 may be formed to have a cylindrical shape, and receive the sleeve holder 15, the sleeve 13, the shaft 11, and the thrust plate 14 therein. In addition, the stator 30 may be seated on an outer circumferential surface of the sleeve support part 25. For this, a seating part 27 that is partially protruded to an outer diameter direction to form a stepped part may be formed on the outer circumferential surface of the sleeve support part 25.

In addition, the base 20 according to the present exemplary embodiment may not include a conventional pulling plate. Accordingly, a size of the base 20 may be enlarged by using a space in which the pulling plate is conventionally provided. Through this, the rigidity of the base 20 according to the present exemplary embodiment may be reinforced, and a shock-absorbing effect absorbing vibrations occurring due to an external shock and the like may be enhanced.

Meanwhile, as for the motor 100 according to the present exemplary embodiment, an eddy current may be generated in a part of the plate part 26 of the base 20 that faces the magnet 42 at the time of initial movement of the rotor 40. A repulsive force may be generated between the rotor 40 and the base 20 by interaction between an electromagnetic field generated by the eddy current and an electromagnetic field generated by the magnet 42 of the rotor 40. The motor 100 according to the present exemplary embodiment may lift the rotor 40 using the repulsive force at the time of initial movement of the rotor 40. This will be further described as below.

The eddy current may denote a spiral-type current created on a metal plate by an electromagnetic induction effect when the metal plate is moved in a strong electromagnetic field, or when an electromagnetic field generated in the metal plate is rapidly changed. In the case of the motor 100, since the magnet 42 is moved while being rotated on the base 20 when the rotor 40 is rotated, the electromagnetic field generated in the metal plate may be changed.

Accordingly, when the base 20 is formed of the metal plate, the eddy current may be generated in a portion of the base 20 facing the magnet 42 by means of the magnet 42 at the time of initial movement of the rotor 40. The eddy current may momentarily allow the base 20 to be a magnetic substance, and an electromagnetic field of the base 20 generated at this time may have a property of pushing each other with an electromagnetic field of the magnet 42, that is, a repulsive force.

The repulsive force may act as a force enabling the rotor 40 to which the magnet 42 is attached to be upwardly lifted. Accordingly, since the rotor 40 may be rotated during a state of being upwardly lifted at the time of movement of the rotor 40, a frictional force applied in a gravitational direction may be minimized and therefore, the rotor 40 may be smoothly rotated.

In the base 20 according to the present exemplary embodiment, since an eddy current generated by a rotation of the rotor 40 and an electromagnetic field due to the eddy current may need to be readily generated, the base 20 may be formed of a non-magnetic substance. That is, the base 20 may be formed of a metallic material, and particularly, desirably formed of an aluminum (Al) alloy material. However, the present invention is not limited thereto, and various materials may used as long as the eddy current and the electromagnetic field due to the eddy current are readily generated by the materials.

Meanwhile, in a case in which the rotor 40 is rotated, when a repulsive force due to the eddy current is consecutively exerted to the rotor 40, the rotor 40 may be excessively lifted by a rotational force of the rotor 40 and the repulsive force of the eddy current.

To solve this problem, in the motor 100 according to the present exemplary embodiment, the thrust dynamic pressure generating parts G1 and G2 may generate the fluid dynamic pressure to the lower side of the axial direction to prevent the rotor case 44 from being lifted. That is, as shown in FIG. 1, the fluid dynamic pressure of the first thrust dynamic pressure generating part G1 where a force (F1) is exerted to the lower side of the axial direction may be greater than the fluid dynamic pressure of the second thrust dynamic pressure generating part G2 where a force (F2) is exerted to the upper side of the axial direction (F1>F2). Accordingly, since the entire fluid dynamic pressure generated in the thrust dynamic pressure generating parts G1 and G2 is exerted to the lower side of the axial direction, the rotor 40 may be prevented from being lifted by a predetermined interval or more when the rotor 40 is rotated.

The motor 100 according to the present exemplary embodiment may enable the rotor 40 to be lifted using the electromagnetic field of the eddy current generated by the magnet 42 and the base 20 at the time of initial movement of the rotor 40, and to be rotated. Accordingly, a frictional force generated between the shaft 11 (or thrust plate) and the bottom surface of the sleeve holder 15 may be minimized at the time of initial movement of the rotor 40, and therefore an generating current may be minimized.

In addition, since the conventional pulling plate is not used, the number of components required for the motor 100 may be reduced, thereby reducing manufacturing costs.

In addition, since the conventional pulling plate is not used, a size of the base 20 may be enlarged using a space occupied by the pulling magnet. Accordingly, rigidity of the base 20 may be enhanced, and an effect of absorbing vibration due to an external shock may be obtained.

Various applications of the motor 100 according to the present exemplary embodiment configured as the above may be possible.

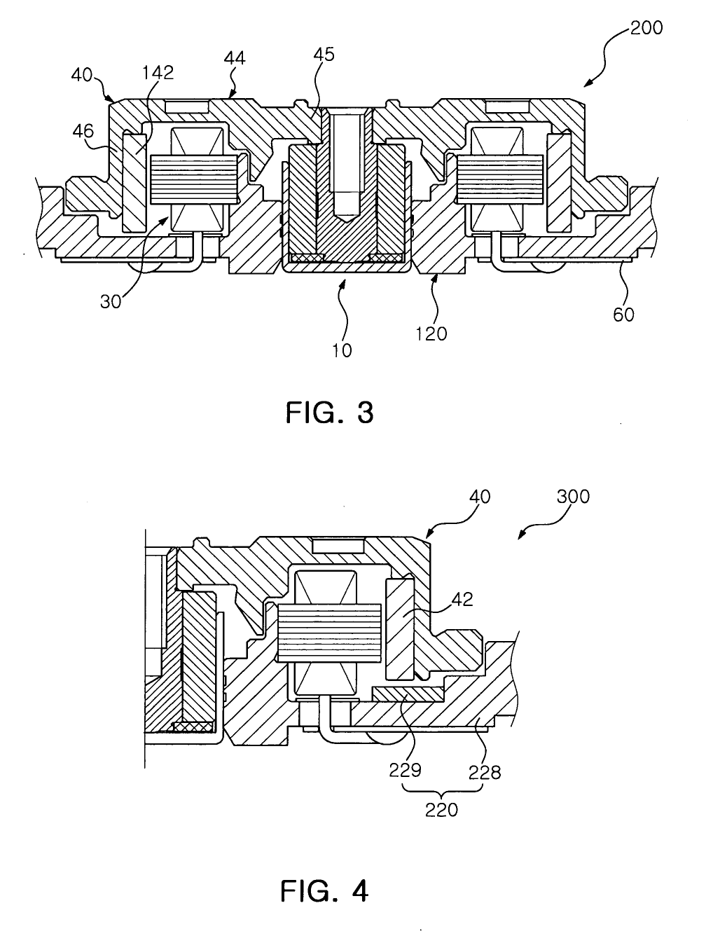

FIG. 3 is a schematic cross-sectional view showing a motor according to another exemplary embodiment of the present invention.

A motor 200 according to the present exemplary embodiment may be configured as having a structure similar to that of the motor 100 of FIG. 1, and a difference therebetween may be shown only in a shape of each of the base 120 and the magnet 142. Accordingly, detailed descriptions of the same components will be omitted, and further descriptions will be made focusing on the shape of each of the base 120 and the magnet 142.

Referring to FIG. 3, the motor 200 according to the present exemplary embodiment may be characterized in that the magnet 142 is fastened to the rotor case 44 such that the motor 200 is protruded to a lower side of the rotor case 44. That is, the magnet 142 according to the present exemplary embodiment may not be completely received in the rotor case 44, and a part of a lower end portion of the magnet 142 may be exposed to an outside of the rotor case 44.

Accordingly, the base 120 according to the present exemplary embodiment may be provided such that the base 20 is formed to be partially removed in comparison with the base 20 of FIG. 1, so that a part of the base 120 facing the lower surface of the magnet 142 is maintained to be spaced from the magnet 142 by a predetermined distance.

In the motor 200 according to the present exemplary embodiment configured as above, since the magnet 142 is not completely received in the rotor case 44, and is partially exposed to the outside, it may be possible to minimize magnetic flux emitted through the lower surface of the magnet 142 to flow into the rotor case 44.

Thus, since a significant amount of magnetic flux flows into the base 120, the intensity of the electromagnetic field generated by the eddy current may be increased, thereby obtaining a greater repulsive force.

FIG. 4 is a schematic cross-sectional view showing a motor according to another exemplary embodiment of the present invention.

The motor 300 according to the present exemplary embodiment may be configured as being a structure similar to that of the motor 100 of FIG. 1, and differences therebetween may be shown only in a shape of the base 220. Accordingly, detailed description of the same components will be omitted, and further descriptions will be made focusing on the shape of the base 220.

Referring to FIG. 4, the base 220 of the motor 300 according to the present exemplary embodiment may include a base body part 228, and an eddy current generating part 229.

The base body part 228 may form the entire shape of the base 220, and the eddy current generating part 229, which will be described later, may be fixedly fastened to the base body part 228 along a part of the base body part 228 facing the lower surface of the magnet 42. The base body part 228 according to the present exemplary embodiment may be formed of various materials. That is, various materials may be used as long as the various materials have rigidity sufficient to protect and support the motor 300 according to the present exemplary embodiment, such as a metal material, a resin material, or the like.

The eddy current generating part 229 may be fastened on the base body part 228 to face the lower surface of the magnet 42 of the rotor 40. The eddy current generating part 229 may be a portion where the eddy current is generated by the magnet 42 at the time of initial movement of the rotor. Accordingly, the material may be diversely applicable as long as the material allows the eddy current by the magnet 42 and the electromagnetic field due to the eddy current to be readily generated. In particular, the eddy current generating part 229 according to the present exemplary embodiment may be preferably formed of an aluminum alloy material; however, the present invention is not limited thereto.

The motor 300 according to the present exemplary embodiment configured as the above may include the eddy current generating part 229 formed of a material that allows the eddy current to be readily generated only in a part of the base 220 where the eddy current is generated, which is different from the entire base 220. Accordingly, the base body part 228 may be formed of various materials regardless of the eddy current, thereby obtaining convenience of manufacturing.

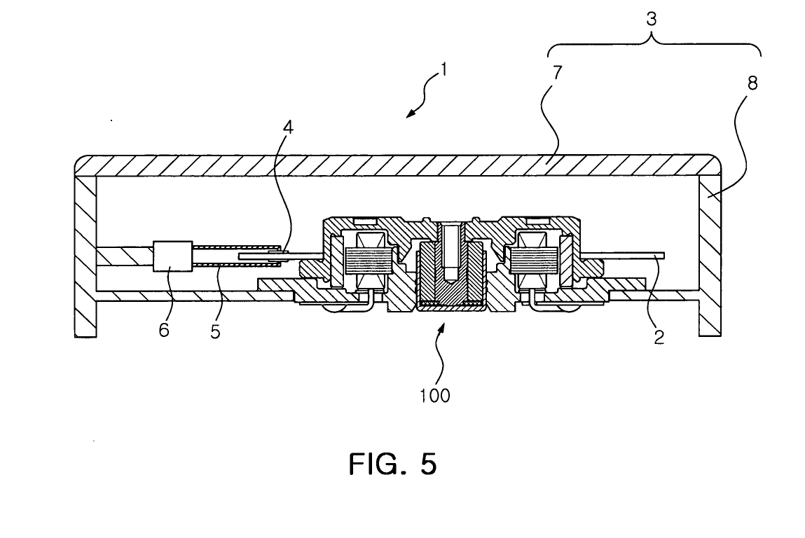

FIG. 5 is a schematic cross-sectional view showing a recording disc driving device to which a motor according to an exemplary embodiment of the present invention is mounted.

Referring to FIG. 5, the recording disc driving device 1 according to the present exemplary embodiment may be a hard disc (HD) driving device, and include the motor 100, a head transfer part 6, and a housing 3.

The motor 100 may be any one of the motors 100, 200, and 300 according to exemplary embodiments of the present invention, and include a recording disc 2 loaded therein.

The head transfer part 6 may transfer, to a surface of the recording disc 2 intended to be detected, a head 4 for detecting information of the recording disc 2 loaded in the motor 100. The head 4 may be disposed on a support part 5 of the head transfer part 6.

The housing 3 may include a top cover 7 for shielding a motor loaded plate 8 and an upper portion of the motor loaded plate 8 in order to form an inner space receiving the motor 100 and the head transfer part 6.

As described above, the motor and the recording disc driving device according to the present invention are not limited to the above described exemplary embodiments, and various changes can be made by those skilled in the art within the sprit and scope of the invention.

For example, according to the above descried exemplary embodiments, a motor in which the stator is positioned in the inside of the motor and the magnet is positioned on the outside of the stator is described. However, the present invention is not limited thereto, and readily applicable in the motor where the magnet is positioned in the inside of the stator.

In addition, according to the above described exemplary embodiments of the present invention, the thrust plate may be fastened to the lower end portion of the shaft; however, the present invention is not limited thereto. That is, various applications may be possible as long as the rotor is configured to be prevented from being separated from the bearing assembly in such a manner that a separate stopper is used to prevent the rotor from being separated from the bearing assembly by fastening the thrust plate to the upper end portion of the shaft.

In addition, according to the above described exemplary embodiments of the present invention, the motor provided in the recording disc driving device (for example, hard disc drive) is described, but otherwise the motor may be diversely applicable as long as the motor includes a bearing using the fluid dynamic pressure.

As set forth above, according to exemplary embodiments of the present invention, the rotor may be lifted using a magnetic field of an eddy current generated between the magnet and the base at the time of initial movement of the rotor. Accordingly, a frictional force generated between the shaft and the sleeve holder may be minimized at the time of initial movement of the rotor, and an generating current may be minimized.

In addition, since the pulling plate used in the related art may not be used, a number of components may be reduced, thereby reducing manufacturing costs.

In addition, since the pulling plate may not be used, a size of the base may be enlarged using a space occupied by the pulling magnet, thereby improving rigidity of the base, and obtaining a shock-absorbing effect absorbing vibration occurring due to an external shock.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor, comprising:
a bearing assembly including a shaft rotatably fastened to the bearing assembly;
a base fastened to a lower end portion of the bearing assembly;
a stator fastened to the base and including a winding coil; and
a rotor case fastened to an upper end portion of the shaft, and including a magnet fastened to the rotor case to be positioned to face the winding coil,
wherein the magnet is fastened to the rotor case in such a manner as to be protruded towards a lower portion of the rotor case so that a magnetic force due to an eddy current generated in the base is increased.

2. The motor of claim 1, wherein the base is formed of a non-magnetic substance.

3. The motor of claim 1, wherien the base is formed of an aluminum alloy material.

4. The motor of claim 1, further comprising an eddy current generating part fastened to the base to face a lower surface of the magnet, and formed of an aluminum alloy material.

5. The motor of claim 1, wherein the bearing assembly includes a thrust dynamic pressure generating part generating a fluid dynamic pressure to a lower side of an axial direction to prevent the rotor case from being lifted.

6. The motor of claim 5, wherein the thrust dynamic pressure generating part includes a first thrust dynamic pressure generating part generating the fluid dynamic pressure to the lower side of the axial direction, and a second thrust dynamaic pressure generating part generating the fluid dynamic pressure to an upper side of the axial direction, and the fluid dynamic pressure generated in the first thrust dynamic pressure generating part is greater than the fluid dynamic pressure generated in the second thrust dynamic pressure generating part.

7. The motor of claim 6, wherein the bearing assembly includes:
a sleeve formed to have a cylindrical shape, and supporting the shaft to be rotatable;
a thrust plate formed to have a ring shape, fixedly fastened to a lower end portion of the shaft, and positioned in a lower space of the sleeve; and
a sleeve holder formed to have a cylindrical shape, and receiving the shaft, the sleeve, and the thrust plate therein.

8. The motor of claim 7, wherein the thrust dynamic pressure generating part is formed on an upper surface of the thrust plate facing a lower surface of the sleeve, and on a lower surface of the thrust plate facing a bottom surface of the sleeve holder, respectively.

9. The motor of claim 8, wherein a fluid dynamic pressure generated in the thrust dynamic pressure generating part formed on the upper surface of the thrust plate is greater than a fluid dynamic pressure generated in the thrust dynamic pressure generating part formed on the lower surface of the thrust plate.

10. The motor of claim 7, wherein the thrust dynamic pressure generating part is formed on the lower surface of the sleeve facing the upper surface of the thrust plate, and on the bottom surface of the sleeve holder facing the lower surface of the thrust plate, respectively.

11. The motor of claim 10, wherein a fluid dynamic pressure generated in the thrust dynamic pressure generating part formed on the lower surface of the sleeve is greater than a fluid dynamic pressure generated in the thrust dynamic pressure generating part formed on the bottom surface of the sleeve holder.

12. A motor, comprising:
a bearing assembly including a shaft rotatably fastened to the bearing assembly;
a base fastened to a lower end portion of the bearing assembly;
a stator fastened to the base and including a winding coil; and
a rotor case fastened to an upper end portion of the shaft, and including a magnet fastened to the rotor case to be positioned to face the winding coil,
wherein the bearing assembly includes a thrust dynamic pressure generating part generating a fluid dynamic pressure to a lower side of an axial direction to prevent the rotor case from being lifted.

13. A recording disc driving device, comprising;
a motor of claim 1;
a head transfer part transferring, to a recording disc, a head for detecting information of the recording disc loaded in the motor; and
a housing receiving the motor and the head transfer part.
